(19) United States
(12) Patent Application Publication
(10) Pub. No.: US 2013/0304623 A1
(43) Pub. Date: Nov. 14, 2013

(54) STOCK RANKING & PRICE PREDICTION BASED ON NEIGHBORHOOD MODEL

(71) Applicant: The Florida State University Research Foundation, Inc., (US)

(72) Inventors: Piyush Kumar, Tallahassee, FL (US); Rajat Raychaudhuri, Tallahassee, FL (US)

(73) Assignee: The Florida State University Research Foundation, Inc., Tallahassee, FL (US)

(21) Appl. No.: 13/865,676

(22) Filed: Apr. 18, 2013

Related U.S. Application Data
(60) Provisional application No. 61/635,039, filed on Apr. 18, 2012.

(51) Int. Cl. G06Q 40/04

(52) U.S. Cl. CPC G06Q 40/04
USPC 705/37

(57) ABSTRACT

A system and method of aggregating and ranking stocks based on the earning capabilities of each stock. The novel system and method use a neighborhood model of pricing trend prediction to aggregate a plurality of “neighboring” or related stocks to predict pricing of one stock within the plurality of related stocks. The system facilitates investors trading stocks by using the novel methodology to rank the stocks and by having an easy-to-use interface.

### BACKGROUND OF THE INVENTION

1. Field of the Invention

This invention relates, generally, to stock rankings and price predictions. More particularly, it relates to a method of using the neighborhood model of pricing trend prediction.

2. Description of the Prior Art

The financial market has always been under close scrutiny by a host of players with varied interests. Yet, due to the profit sensitive nature of the context, the existing literature is by no means complete and/or succinct.

Prominent firms tend not to publish their work since that analyses is their bread and butter. Academicians mostly stop at theorizing since the continual financial feed and other experiments are difficult to obtain.

Attempts have been made in ranking and/or modeling the performance of stocks using neural nets, but this conventional approach tends to be ineffective and time-consuming.

Because of feelings of unpredictability in stocks, few people actually attempt the stock market as a serious money making option. The web interface between the investor and the market also has not evolved much and more importantly is not an inviting one. As a result, despite being a lucrative option, the market has not been able to attract as many investors as it should have been by this day given the advancement of computing power.

People want information, rather than data, yet many of the prominent financial websites (e.g., GOOGLE Finance, YAHOO Finance, FIDELITY, CNN Money, etc.) stop only at providing the end user with a vast amount of data in an uninviting interface. As depicted in FIG. 1, the NEW YORK TIMES published a report in August 2009 claiming that fewer people are using the finance pages of GOOGLE compared to its other services. It becomes very difficult for a budding investor to arrive at a verdict about a ticker based only on that data unless he/she is a finance guru. Instead of guiding the user, the overwhelming number of market parameters and business documents often scare the user away from making a trade.

The interfaces provided by these finance firms are neither complete nor succinct. Most of these websites provide a snapshot of the behavior of a ticker in their main page with some predictions (using a green ↑ symbol or a red ↓ symbol) about the ticker price. There is no way to know how accurate their forecasts have been in the past. Regardless, the user cannot rank the tickers based on different parameters, such as P/E Ratio, percentage change in price, EPS forecast, etc.

None of these firms rank tickers that fall within a given price range. None of the firms have the feature to rank or recommend tickers given a certain price range.

While analyzing the stock market, academicians mostly stop at theorizing since the continual financial feed is expensive. Most researchers deal with per day samples. Given the growth of processing power and applications based on machine learning algorithms in last decade, the existing technology in this area is conspicuously poor.

U.S. Patent Application Publication No. 2010/0280976 discloses aggregating investment data and real-time trade data of investors and ranking the investors according to investment performance derived from the investment data. However, these rankings are not based on time series data (e.g., ticker price) itself, which would allow the ranking of tickers in terms of earning capability. Rather, this patent application ranks an investor portfolio based on acquired profit.

Accordingly, what is needed is an effective mechanism of ranking stock. However, in view of the art considered as a whole at the time the present invention was made, it was not obvious to those of ordinary skill how the art could be advanced.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### SUMMARY OF THE INVENTION

The long-standing but heretofore unfulfilled need for an improved, more effective and accurate method of ranking stocks and predicting prices is now met by a new, useful and nonobvious invention.

Certain embodiments of the current invention solve the problem of predicting the trend of a continuous time series, given the knowledge of other similar time series, where the price of stock is the time series. Certain embodiments of the current invention also solve the proximal problem of rank aggregation, which is, given a set of rankings based on some parameters, to come up with an optimal ranking that procures the earning capability of a ticker as the primary pivot.

To achieve solutions to these problems, the current invention projects each ticker as a point on a higher dimensional space (e.g., six dimensional space). Then approximate nearest neighbor algorithms are used to build the neighborhood model. It is hypothesized that the pricing trend of a ticker can be guessed in the near future given the knowledge of its neighbor. The pros and cons of three methodologies (Hidden Markov Model, Neural Nets, and simple Monte Carlo Simulation) are being tested to refine the hypothesis.

In terms of rank aggregation, the current invention receives the rankings of leading market analyses. A tentative ranking is generated out of these market analyses using a Condorcet method. The system is completed as a Supervised Learning Model by augmenting a feedback loop, which takes the day-to-day performance of stocks as baseline/ground fact. The system then becomes self-correcting as well.

The current invention further includes rankings of tickers registered at NASDAQ based on different market parameters, such as earning capability, P/E ratio, traded volume, etc.

The current invention further includes ranking of tickers within a given sector, such as energy, electronics, etc.

The current invention further includes rank charts, which are charts that depict a ticker's rank at different hours of the day, rather than the price of the ticker. This is in contrast to a continuous curve showing ticker price. The rankings would be calculated after a certain interval and shown accordingly. The value of this interval can be configured by the administrator of the system.

The current invention further includes a recommendation based on portfolio and budget.

The current invention further includes a short term prediction with reason (i.e., why ticker X was given rank 1) and past accuracy in prediction.

These and other important objects, advantages, and features of the invention will become clear as this disclosure proceeds.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the nature and objects of the invention, reference should be made to the following detailed disclosure, taken in connection with the accompanying drawings, in which:

FIG. 1 depicts a graph illustrating of use of firms' financial websites as published in a New York Times report in August 2009;

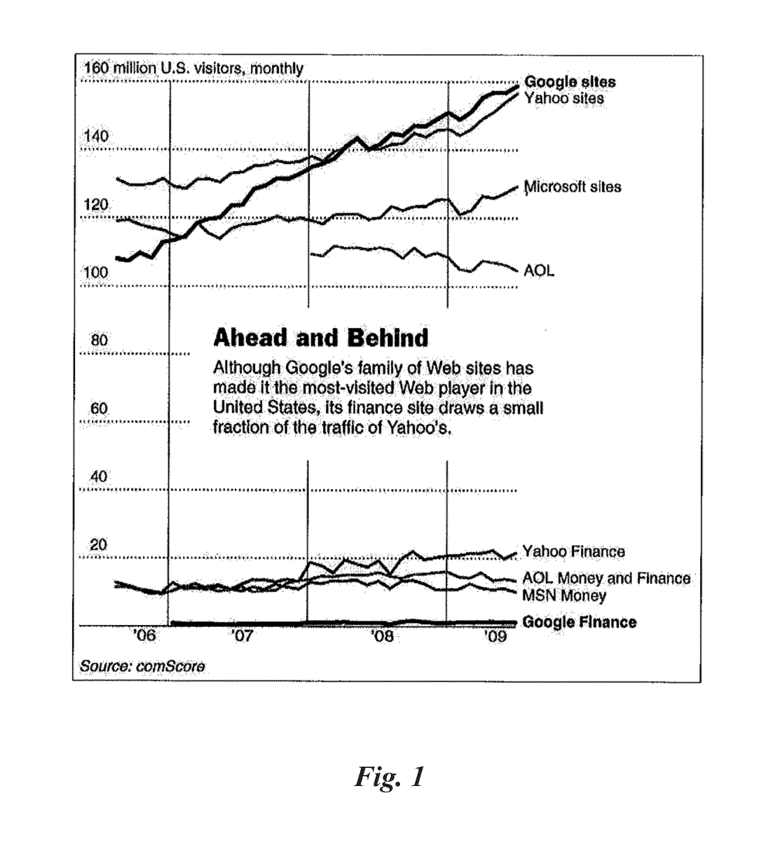

FIG. 2 depicts a screenshot of the project description section of an embodiment of the current invention; and

FIG. 3 depicts a screenshot of the featured works section of an embodiment of the current invention.

FIG. 4 depicts a stock neighborhood of the GOOGLE stock.

### DETAILED DESCRIPTION OF THE PREFERRED EMBODIMENT

In the following detailed description of the preferred embodiments, reference is made to the accompanying drawings, which form a part thereof, and within which are shown by way of illustration specific embodiments by which the invention may be practiced. It is to be understood that other embodiments may be utilized and structural changes may be made without departing from the scope of the invention.

The current invention is based on the neighborhood model of pricing trend prediction. Stock tickers registered at NASDAQ are ranked by blending their daily performance with the opinions of leading market analysis. Pricing trends (i.e., whether a ticker price appears to be going up or down) can also be predicted immediately where the user is allowed to choose the amount of history data to take into account while making the decision (i.e., whether to base the decision on the past six month's data or on the past one week's data).

Generally the current invention transforms the financial math problem into the paradigm of machine learning. By doing so, the current invention solves the problem of predicting the trend of a continuous time series, given the knowledge on other similar time series. The current invention also solves the proximal problem of rank aggregation, which is, given a set of rankings based on some parameters, to generate an optimal ranking that procures the earning capability of a ticker as the primary pivot. Data is used from multiple tickers (i.e., the neighbors) to predict the price of a single ticker.

Two systems are being used at present. The first is essentially a smart web crawler designed to capture the time series data. the second builds the aforementioned neighborhood model and calculates the ranking The parameters of the neighborhood builder and the ranking engine are being fine-tuned to make these two systems converge and work in a highly cohesive manner.

Many features of the current invention can be implemented using filters. Filters may appear on the interface (i.e., the website) as drop-down menus and/or check boxes. The user may also have the ability to create an account to store a personal portfolio.

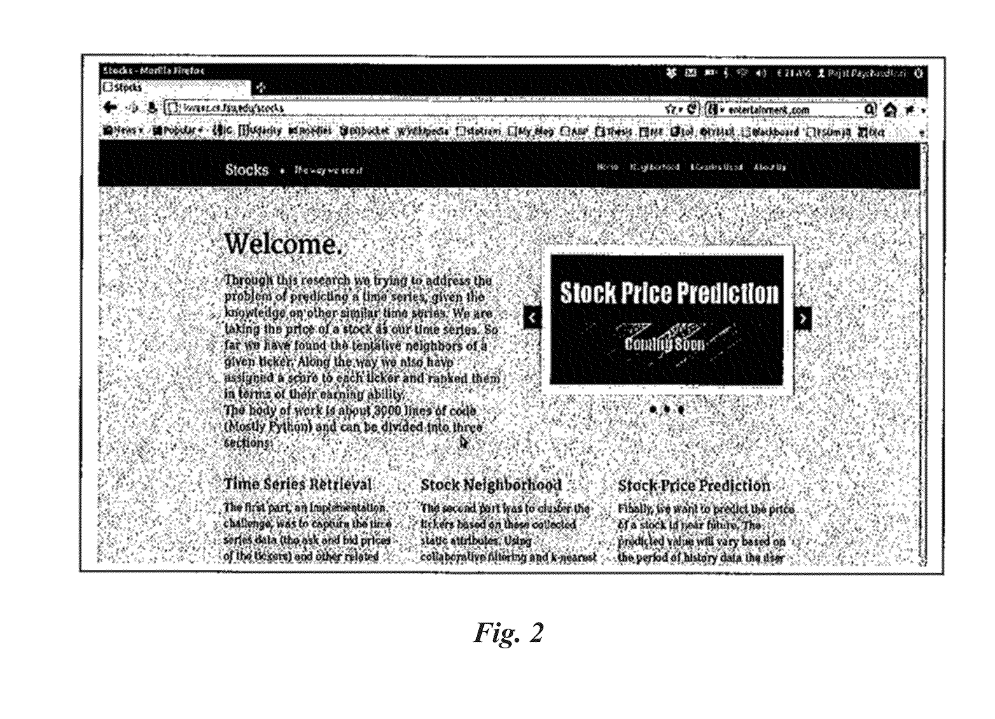

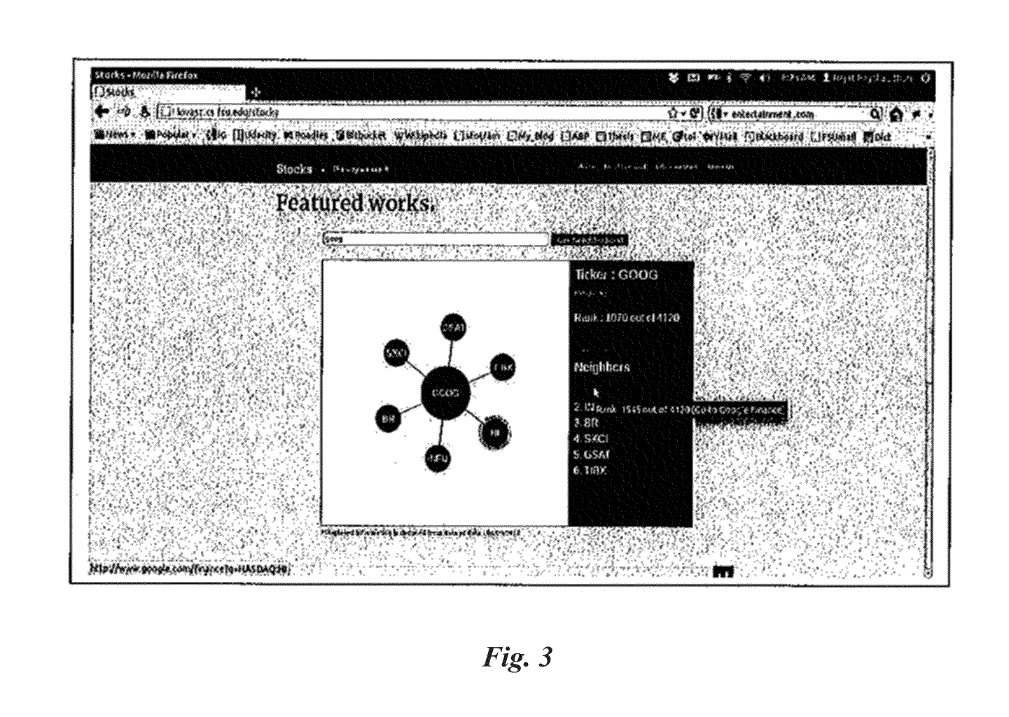

FIGS. 2 and 3 depict prototypes of the current invention. The neighborhood model has been developed, and progress is being made in the areas of rankings and recommendations. Any known data sources may be utilized in the current invention, including, but not limited to, crawled data and market data feed.

### Example

Through this research, the problem of predicting a time series was addressed, given the knowledge on other similar time series. The price of a stock was taken as the time series. The tentative neighbors of a given ticker were found. Along the way, a score was assigned to each ticker and ranked in terms of their earning ability.

The body of work is about 3000 lines of code (Mostly Python) and can be divided into three sections:

(1) Time Series Retrieval

Time series retrieval involves retrieving and store ask price and bid price of all stock tickers in NASDAQ.

This first part, an implementation challenge, was to capture the time series data (the ask and bid prices of the tickers) and other related attributes for each ticker. Using the current exemplary system, samples for each ticker registered in NASDAQ were able to be captured on an average five seconds apart without having to subscribe to any finance data feed.

(2) Stock Neighborhood

The stock neighborhood involves ranking the stock tickers in terms of non-time sensitive properties and finding neighbors.

This second part was to cluster the tickers based on these collected static attributes. Using collaborative filtering and k-nearest neighbors we have found six closest tickers for each collected ticker. We are also working to aggregate the ranking on stocks based on different attributes.

(3) Stock Price Prediction

Finally, it is desired to predict the price of a stock. The predicted value will vary based on the period of history data the user wishes to use. Hidden Markov Model is the most popular method of time series prediction. The current invention also contemplates Neural nets and Monte Carlo methods to accomplish this goal.

The libraries used include Graphlab, STANN, MDP, Jquery, Flask, and Raphael. However, the current invention contemplates use of any known libraries for use in various embodiments.

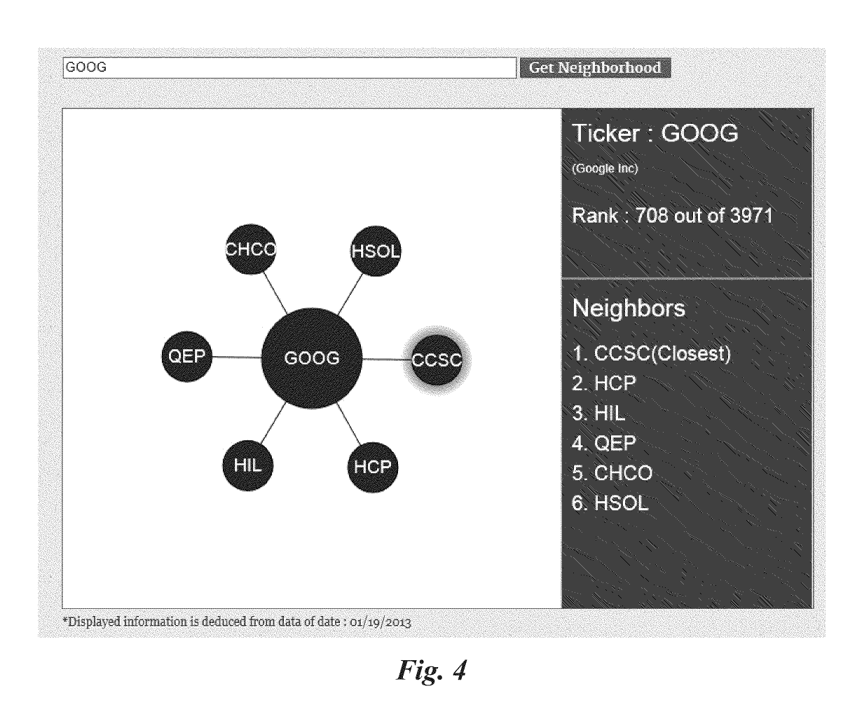

FIG. 4 depicts a stock neighborhood of the GOOGLE stock.

### Software Implementation

Certain embodiments of the current invention include a computer-implemented software application. The software is accessible from a non-transitory, computer-readable media and provide instructions for a computer processor to rank stocks, develop stock neighborhoods, and/or predict pricing within a stock market.

The computer-readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, radio frequency, etc., or any suitable combination of the foregoing. Computer program code for carrying out operations for aspects of the present invention may be written in any combination of one or more programming languages, including an object oriented programming language such as Java, C#, C++ or the like and conventional procedural programming languages, such as the “C” programming language or similar programming languages.

The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified.

It will thus be seen that the objects set forth above, and those made apparent from the foregoing disclosure, are efficiently attained. Since certain changes may be made in the above construction without departing from the scope of the invention, it is intended that all matters contained in the foregoing disclosure or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

What is claimed is:

1. A computer-implemented software application, the software accessible from a non-transitory, computer-readable media and providing instructions for a computer processor to rank a plurality of stocks, fabricate a stock neighborhood including said plurality of stocks, and predict pricing within a stock selected from said plurality of stocks, the instructions comprising:
receiving and storing time series data of a plurality of stocks registered at NASDAQ, said time series data including ask prices and bid prices of said plurality of stocks;
ranking said plurality of stocks by blending daily performance of said plurality of stocks with conventional market analyses, said ranking based on non-time sensitive properties;
fabricating a stock neighborhood based on said ranking of said plurality of stocks, said stock neighborhood being an optimal ranking;
receiving user input regarding an amount of history data of each of said plurality of stocks;
developing pricing trends for said each stock based on said amount of history data; and
predicting the trend of a continuous time series based on said pricing trends.
